(19) United States
(12) Patent Application Publication
(10) Pub. No.: US 2013/0107899 A1
(43) Pub. Date: May 2, 2013

(54) LASER APPARATUS

(71) Applicant: Gigaphoton Inc., Tochigi (JP)

(72) Inventors: Takashi MATSUNAGA, Tochigi (JP); Masaya Yoshino, Tochigi (JP); Osamu Wakabayashi, Kanagawa (JP)

(73) Assignee: Gigaphoton Inc., Tochigi (JP)

(21) Appl. No.: 13/657,964

(22) Filed: Oct. 23, 2012

(30) Foreign Application Priority Data
Oct. 28, 2011 (JP) 2011-237484

(51) Int. Cl. H01S 3/10

(52) U.S. Cl. 372/20

(57) ABSTRACT

A laser apparatus may include a laser oscillator capable of tuning a spectral bandwidth of a laser beam to be outputted therefrom, a spectrum detecting unit that detects a spectrum of the laser beam outputted from the laser oscillator and an attenuation unit capable of regulating light intensity of the laser beam that enters the spectrum detecting unit. The attenuation unit may include a variable attenuator whose transmittance varies depending on an incident position of the laser beam and a movement mechanism that moves the variable attenuator so that the incident position of the laser beam is changed.

### CROSS-REFERENCE TO RELATED APPLICATION

The present application claims priority from Japanese Patent Application No. 2011-237484 filed Oct. 28, 2011.

### TECHNICAL FIELD

The present disclosure relates to laser apparatuses.

### RELATED ART

The miniaturization and increased levels of integration of semiconductor integrated circuits have led to a demand for increases in the resolutions of semiconductor exposure apparatuses (hereinafter, referred to as “exposure apparatuses”). Accordingly, advances are being made in the reduction of the wavelengths of light emitted from exposure light sources. Gas laser apparatuses are being used as exposure light sources instead of conventional mercury lamps. At present, a KrF excimer laser apparatus that outputs ultraviolet light at a wavelength of 248 nm and an ArF excimer laser apparatus that outputs ultraviolet light at a wavelength of 193 nm are used as gas laser apparatuses for exposure.

Immersion exposure, in which a gap between an exposure lens of an exposure apparatus and a wafer is filled with a liquid to change the refractive index so that the apparent wavelength of an exposure light source is reduced, has been researched as a next-generation exposure technique. In the case where immersion exposure is carried out using an ArF excimer laser apparatus as the exposure light source, the wafer can be irradiated with ultraviolet light at a wavelength of 134 nm within the liquid. This technique is called “ArF immersion exposure” (or “ArF immersion lithography”).

The spontaneous oscillation widths of a KrF excimer laser apparatus and an ArF excimer laser apparatus are relatively wide to be approximately 350 to 400 pm. Therefore, if a projection lens is used in an exposure apparatus, chromatic aberration occurs and consequently the resolution is caused to drop in some case. Accordingly, it is necessary to narrow the spectral bandwidth (spectrum width) of the laser beam emitted from a gas laser apparatus until the chromatic aberration becomes small enough to be ignored. In recent years, a line narrow module having a line narrowing element (an etalon, a grating or the like) has been provided within a laser resonator of a gas laser apparatus so as to narrow the spectrum width. A laser apparatus in which the spectrum width is narrowed in the manner described above is called a line narrow laser apparatus.

### SUMMARY OF INVENTION

A laser apparatus according to an aspect of the present disclosure may include: a laser oscillator capable of tuning a spectral bandwidth of a laser beam to be outputted therefrom; a spectrum detecting unit that detects a spectrum of the laser beam outputted from the laser oscillator; and an attenuation unit capable of regulating light intensity of the laser beam that enters the spectrum detecting unit.

### BRIEF DESCRIPTION OF THE DRAWINGS

Exemplary embodiments of the present disclosure will be described hereinafter with reference to the appended drawings.

FIG. 1 schematically illustrates an example of a configuration of a laser apparatus according to a first embodiment of the present disclosure.

FIG. 2 is a flowchart illustrating the main routine of a controller according to the first embodiment.

FIG. 3 illustrates an example of an adjustment oscillation subroutine indicated in the main routine of the controller of FIG. 2.

FIG. 4 illustrates an example of a displacement amount calculation subroutine indicated in the adjustment oscillation subroutine of FIG. 3.

FIG. 5 illustrates an example of a spectral detector that includes an attenuation unit using a rotation-type variable attenuator.

FIG. 6 illustrates an example of a configuration of the variable attenuator shown in FIG. 5 when viewed from an incident direction of a laser beam.

FIG. 7 illustrates an example of a spectral detector that includes an attenuation unit using a slide-type variable attenuator.

FIG. 8 illustrates an example of a configuration of the variable attenuator shown in FIG. 7 when viewed from the incident direction of a laser beam.

FIG. 9 illustrates an example of a spectral detector that includes an attenuation unit using an incident angle adjusting-type variable attenuator.

FIG. 10 illustrates another example of a spectral detector that includes an attenuation unit using an incident angle adjusting-type variable attenuator.

FIG. 11 illustrates a still another example of a spectral detector that includes an attenuation unit using a variable attenuator.

FIG. 12 illustrates an example of a configuration of a wave-front tuning unit shown in FIG. 1.

FIG. 13 illustrates another state of the wave-front tuning unit shown in FIG. 12.

FIG. 14 illustrates another example of the wave-front tuning unit shown in FIG. 1.

FIG. 15 is a side view of the wave-front tuning unit shown in FIG. 14.

FIG. 16 illustrates an example of a magnification adjusting unit shown in FIG. 1.

FIG. 17 illustrates another state of the magnification adjusting unit shown in FIG. 16.

FIG. 18 illustrates another example of the magnification adjusting unit shown in FIG. 1.

FIG. 19 schematically illustrates a general configuration of an amplifying apparatus configured as a power amplifier according to an embodiment.

FIG. 20 schematically illustrates a general configuration of an amplifying apparatus using a power oscillator equipped with a Fabry-Perot resonator according to an embodiment.

FIG. 21 schematically illustrates a general configuration of an amplifying apparatus using a power oscillator equipped with a ring resonator according to an embodiment.

FIG. 22 is a cross-sectional view of the configuration shown in FIG. 21 when rotated by 90 degrees about an optical path of a laser beam as an axis.

FIG. 23 schematically illustrates a general configuration of a spectrum detecting unit according to an embodiment.

FIG. 24 schematically illustrates another general configuration of a spectrum detecting unit according to an embodiment.

### DETAILED DESCRIPTION

Embodiments of the present disclosure will be described in detail hereinafter with reference to the drawings. The embodiments described hereinafter indicate examples of the present disclosure, and are not intended to limit the content of the present disclosure. Furthermore, not all of the configurations and operations described in the embodiments are required configurations and operations of the present disclosure. Note that identical constituent elements will be given identical reference numerals, and redundant descriptions thereof will be omitted.

In the following descriptions, the embodiments will be explained according to the order of the following table of contents.

### Contents

### 1. Outline

### 2. Explanation of Terms

3. Laser Apparatus with Variable Spectral Bandwidth for Exposure Apparatus

3.1 Configuration

3.2 Operations

3.3 Effect

3.4 Flowchart
3.4.1 Main Routine
3.4.2 Adjustment Oscillation Subroutine (Peak Intensity Regulation Included)
3.4.3 Displacement Amount Calculation Subroutine

### 4. Variable Attenuator

4.1 Rotation-Type Variable Attenuator

4.2 Slide-Type Variable Attenuator

4.3 Incident Angle Adjusting-Type Variable Attenuator

4.4 Incident Angle Adjusting-type Variable Attenuator

### (Variation)

### 5. Spectral Detector Including Variable Attenuator

5.1 Configuration

5.2 Operations

5.3 Effect

### 6. Wave-Front Tuning Unit

6.1 Wave-Front Tuning Mechanism Separated from Output Coupling Mirror

6.2 Wave-Front Tuning Mechanism Integrated with Output Coupling Mirror

### 7. Magnification Adjusting Unit

7.1 Magnification Adjusting Unit Including Prism Switching Mechanism

7.2 Magnification Adjusting Unit Including Prism Rotation Mechanism

### 8. Amplifying Apparatus

8.1 Power Amplifier with Excimer Gas as Gain Medium

8.2 Power Oscillator with Excimer Gas as Gain Medium
8.2.1 Embodiment Including Fabry-Perot Resonator
8.2.2 Embodiment Including Ring Resonator

### 9. Spectrum Detecting Unit

9.1 Monitor Etalon Spectroscope

9.2 Grating Spectroscope

### 1. Outline

In order to expose various kinds of mask patterns, an ultraviolet light laser apparatus for an exposure apparatus is required to output the laser beams each having a spectral bandwidth that appropriately corresponds to each of the mask patterns. In this case, each of the spectral bandwidths outputted from the laser apparatus is needed to be precisely detected. Accordingly, the following embodiments may include a variable attenuator that regulates light intensity or peak intensity of a laser beam which is incident on an image sensor. Using the variable attenuator mentioned above makes it possible to regulate the peak intensity detected by the image sensor even in the case where the spectral bandwidth largely changes. As a result, even if the spectral bandwidth largely changes, desired precision of detection of the spectral bandwidth and a center wavelength can be maintained.

### 2. Explanation of Terms

Terms used in the present disclosure are defined as follows. “Upstream side” is a side toward a light source along an optical path of a laser beam. Meanwhile, “downstream side” is a side toward an exposure apparatus along the optical path of the laser beam. “Prism” is an object that is formed in a triangle pole or triangle pole-like shape and capable of transmitting light including a laser beam. The top face and bottom face of a prism are formed in a triangle or triangle-like shape. The three faces that intersect with the top face and the bottom face at approximately 90 degrees are each called a “lateral face”. In the case of a right-angle prism, among these lateral faces, a face that does not intersect at 90 degrees with the other two faces is called a “slanted face”. It is to be noted that a prism whose shape is deformed by cutting lateral edges thereof or the like can be also included in the prism discussed in this description. “Optical axis” may be an axis that passes through approximately the center of the beam cross-section of a laser beam along a travelling direction of the laser beam.

3. Laser Apparatus with Variable Spectral Bandwidth for Exposure Apparatus

A laser apparatus according to a first embodiment of the present disclosure will be described in detail hereinafter with reference to the drawings.

### 3.1 Configuration

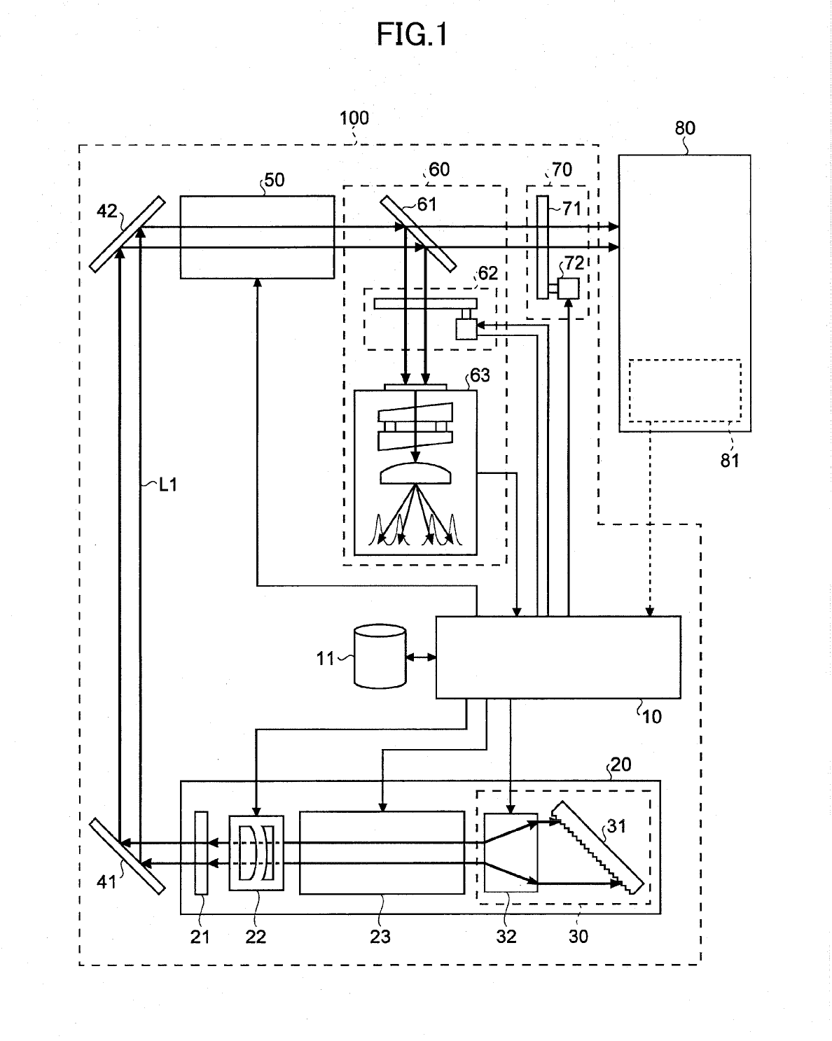

FIG. 1 schematically illustrates an example of a configuration of a laser apparatus according to the embodiment. A laser apparatus 100 may be a laser apparatus for semiconductor exposure. The laser apparatus 100 may be a two-stage laser apparatus having an oscillation stage (master oscillator) and an amplifying stage (amplifying apparatus). The laser apparatus 100 is at least capable of changing the spectral bandwidth of a laser beam.

As shown in FIG. 1, the laser apparatus 100 may include a controller 10, a master oscillator system 20, an amplifying apparatus 50, and a spectral detector 60. The laser apparatus 100 may further include optical systems such as highly reflective mirrors 41 and 42, and a shutter mechanism 70. The laser apparatus 100 may furthermore include a storage unit 11 connected with the controller 10.

The controller 10 may control the overall laser apparatus 100. The controller 10 may be connected with the master oscillator system 20, the amplifying apparatus 50, the spectral detector 60, and the shutter mechanism 70. Further, the controller 10 may be connected to a controller 81 of an exposure apparatus 80.

The master oscillator system 20 may output a laser beam L1. The laser beam L1 may be a pulsed beam of light. The master oscillator system 20 may include a line narrow module 30, an amplifier 23, and an output coupling mirror 21. The line narrow module 30 may include a magnification adjusting unit 32 and a grating 31. The grating 31 and the output coupling mirror 21 may form an optical resonator. The grating 31 may function as a wavelength selection unit of the laser beam L1. The output coupling mirror 21 may function as an output terminal of the laser beam L1 in the master oscillator system 20.

The amplifier 23, when in an excited state, may amplify a laser beam L1 that travels in the optical resonator. The magnification adjusting unit 32 may enlarge or reduce the beam cross-section of the laser beam L1 that travels in the optical resonator. Through this, the spectral bandwidth of the laser beam L1 can be tuned. The master oscillator system 20 may further include a wave-front tuning unit 22. The wave-front tuning unit 22 may tune a wave-front of the laser beam L1 that travels in the optical resonator. By tuning the wave-front of a laser beam, the spectral bandwidth of the laser beam can be tuned. The amplifier 23, the wave-front tuning unit 22 and the magnification adjusting unit 32 may operate under the control from the controller 10.

The optical systems such as the highly reflective mirrors 41 and 42 may be disposed on an optical path between the master oscillator system 20 and the amplifying apparatus 50. The amplifying apparatus 50 may amplify the laser beam L1 that has entered the amplifying apparatus 50 via the optical systems. The amplifying apparatus 50 may include an excimer gas or the like inside thereof and make the gas to be in an excited state by discharge so as to use it as a gain medium. The amplifying apparatus 50 may operate under the control from the controller 10.

The spectral detector 60 may be disposed on an optical path downstream of the amplifying apparatus 50. The spectral detector 60 may include a beam splitter 61, an attenuation unit 62, and a spectrum detecting unit 63. The beam splitter 61 may be disposed on an optical path of the laser beam L1 outputted from the amplifying apparatus 50.

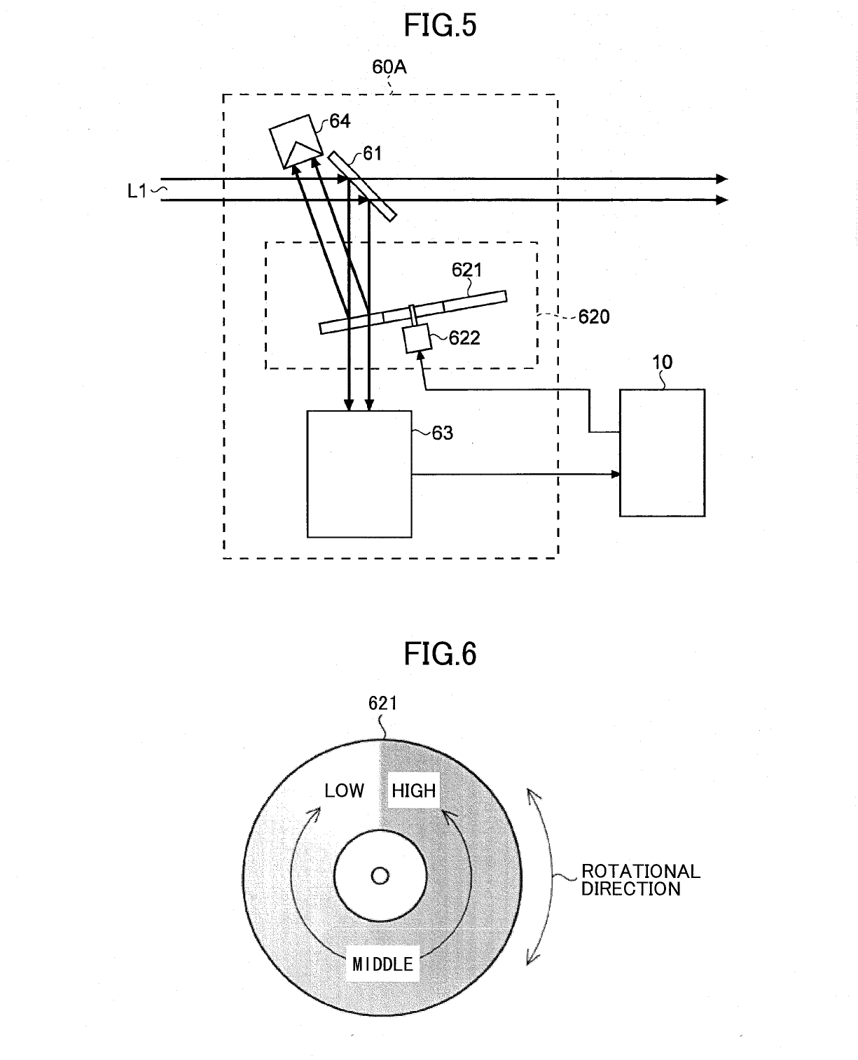

The attenuation unit 62 may be disposed on an optical path of the laser beam L1 split by the beam splitter 61. The attenuation unit 62 may include a variable attenuator and a movement mechanism, which will be described later (for example, see FIG. 5). The movement mechanism may adjust an incident position of a laser beam on the variable attenuator so as to tune an attenuation rate of the attenuation unit 62.

The spectrum detecting unit 63 may detect a spectrum of the laser beam L1 that has passed through the attenuation unit 62. The spectrum detecting unit 63 may output the detected result of the spectrum of the laser beam L1 to the controller 10.

The shutter mechanism 70 may be disposed on an optical path downstream of the spectral detector 60. The shutter mechanism 70 may include a shutter 71 and a driving mechanism 72. The driving mechanism 72 may push/pull the shutter 71 to/from an optical path of the laser beam L1. The driving mechanism 72 may operate under the control from the controller 10. The laser beam L1 that has passed through the shutter mechanism 70 with the shutter 71 being opened may be outputted to the exposure apparatus 80.

### 3.2 Operations

Next, an overview of operations of the laser apparatus 100 shown in FIG. 1 will be described below. The controller 10 may receive an exposure command that requires output of a laser beam L1 for exposure from the controller 81 of the exposure apparatus 80. The exposure command may include a target value of the spectral bandwidth (target spectral bandwidth) of the laser beam L1 to be provided. Upon receiving the exposure command, the controller 10 may first drive the shutter mechanism 70 to close the shutter 71. In addition, the controller 10 may drive the wave-front tuning unit 22 and the magnification adjusting unit 32 so that the spectral bandwidth of the laser beam L1 comes to be a required target spectral bandwidth. The storage unit 11 may store the control values of the wave-front tuning unit 22 and/or the magnification adjusting unit 32 in a manner such that the control values are related to the target spectral bandwidth. The relationship between the control values and the target spectral bandwidth may be managed in a control table data format. Alternatively, the storage unit 11 may store functions, parameters and the like for calculating the control values from the target spectral bandwidth. The controller 10 may calculate the control values to realize the target spectral bandwidth using the functions and parameters read out from the storage unit 11. The controller 10 may appropriately send the obtained control values to the wave-front tuning unit 22 and the magnification adjusting unit 32. Further, the controller 10 may drive the amplifier 23 in the master oscillator system 20 so as to make it in an excited state. This makes it possible for the master oscillator system 20 to output the laser beam L1 whose spectral bandwidth is substantially adjusted to the target spectral bandwidth.

The controller 10 may drive the amplifying apparatus 50 into an excited state in synchronization with a timing at which a laser beam L1 outputted from the master oscillator system 20 enters the amplifying apparatus 50. Through this, the laser beam L1 outputted from the master oscillator system 20 can be amplified by the amplifying apparatus 50.

The amplified laser beam L1 may enter the beam splitter 61 of the spectral detector 60. The laser beam L1 split by the beam splitter 61 may pass through the attenuation unit 62. The attenuation unit 62 may regulate the light intensity or peak intensity of the laser beam L1 passing therethrough in accordance with the spectral bandwidth of the laser beam L1. The spectral detector 60 may detect the spectral bandwidth of the laser beam L1 having experienced the above intensity regulation. The detected spectral bandwidth may be sent to the controller 10. The controller 10 may perform feedback control on at least one of the wave-front tuning unit 22 and the magnification adjusting unit 32 so that the detected spectral bandwidth comes closer to the target spectral bandwidth. Further, the controller 10 may perform feedback control on the attenuation unit 62 in accordance with the detected spectral bandwidth.

### 3.3 Effect

According to the above description, the attenuation rate of the attenuation unit 62 can be tuned in response to a change of spectral bandwidth. Therefore, it is possible to stabilize light intensity or peak intensity of a laser beam L1 that enters the spectrum detecting unit 63. For example, in order to cause the peak intensity of the laser beam L1 that enters the spectrum detecting unit 63 to fall within a specified dynamic range, the light intensity or the peak intensity of the laser beam L1 can be regulated. Consequently, even if the spectral bandwidth is largely changed, the spectral bandwidth, the center wavelength and the like can be detected with high precision within the dynamic range.

### 3.4 Flowchart

Next, operations of the laser apparatus 100 according to the first embodiment will be described in detail referring to the drawings. Note that hereinafter, the operations thereof will be explained through operations of the controller 10.

### 3.4.1 Main Routine

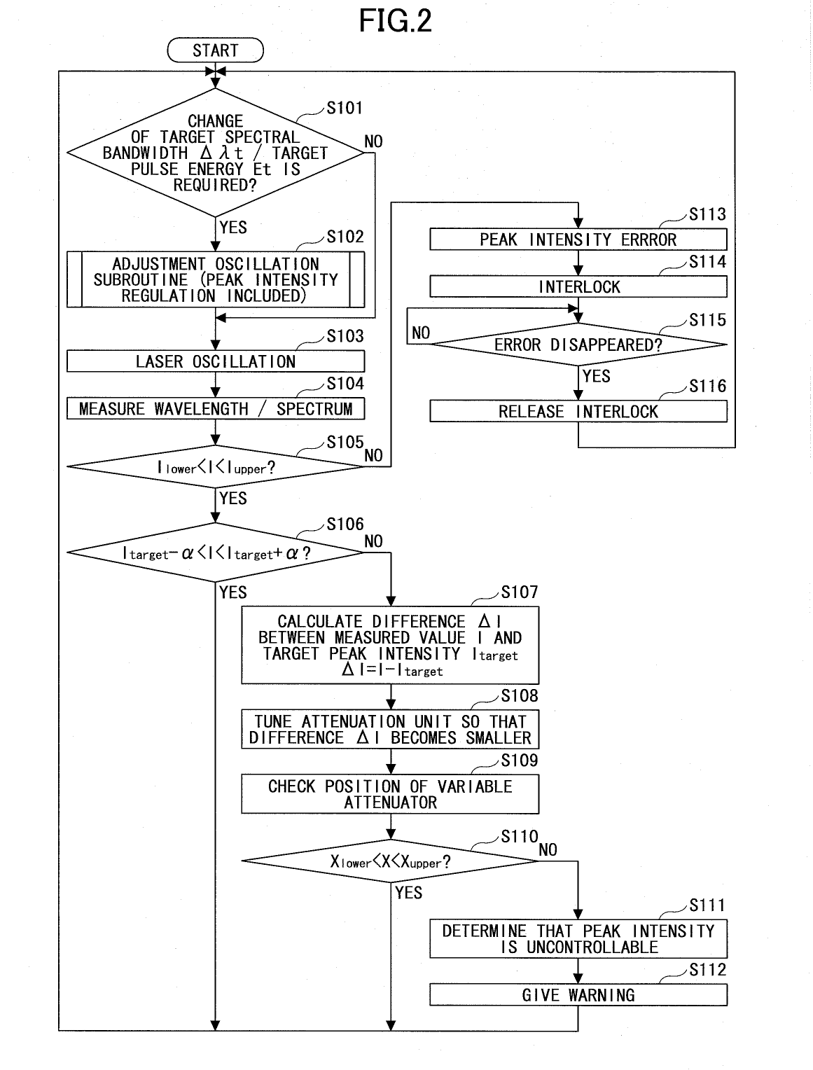

FIG. 2 is a flowchart illustrating the main routine of the controller 10 according to the first embodiment. As shown in FIG. 2, the controller 10 may determine first whether or not a change instruction that requires change of a target spectral bandwidth Δλt and/or a target pulse energy Et has been received from an external device such as the exposure apparatus controller 81 (step S101). The change instruction may be included in the exposure command or the like that requires output of a laser beam.

If the change instruction has been received (step S101; YES), the controller 10 may execute an adjustment oscillation subroutine (step S102), thereafter may proceed to step S103. An operation that regulates the peak intensity of a laser beam L1 entering the spectrum detecting unit 63 in order for the peak intensity thereof to fall within a predetermined dynamic range, maybe included in the adjustment oscillation subroutine. Meanwhile, if the change instruction has not been included (step S101; NO), the controller 10 may directly proceed to step S103.

In step S103, the controller 10 may drive the master oscillator system 20 and the amplifying apparatus 50 so as to output the laser beam L1. Next, the controller 10 may measure a spectrum of the laser beam L1 outputted in step S103 using the spectral detector 60 (step S104). The measurement result may include information of a center wavelength λ and peak intensity I. Subsequently, the controller 10 may determine from the measurement result of the spectrum whether or not the peak intensity I of the laser beam L1 is included in a predetermined dynamic range (I_{lower}<I<Iᵤₚₚₑᵣ) (step S105). The predetermined dynamic range may be a range where, for example, detection precision which is easy to be used can be obtained based on a sensitivity characteristic of the spectrum detecting unit 63.

If the peak intensity I of the laser beam L1 is included in the predetermined dynamic range (step S105; YES), the controller 10 may determine whether or not the peak intensity I is included in an attenuation-tuning unnecessary range (step S106). The attenuation-tuning unnecessary range may be a range in which the attenuation unit 62 is not needed to be tuned for the peak intensity I of the laser beam L1. For example, with a target peak intensity I_{target} set as a reference value, a range of the target peak intensity I_{target}±α may be defined as the attenuation-tuning unnecessary range.

The value a that defines the width of the attenuation-tuning unnecessary range may be predetermined. In this case, the value α may be stored in the storage unit 11. The value a may be predetermined based on, for example, the sensitivity characteristic, resolution or the like of the spectrum detecting unit 63. The determination processing in step 106 may be executed for each pulse or an average value of a plurality of pulses (for example, average value of 100 pulses or 1,000 pulses).

If the peak intensity I is within the attenuation-tuning unnecessary range (step S106; YES), the controller 10 may return to step S101 and execute the subsequent processings therefrom. On the other hand, if the peak intensity I is out of the attenuation-tuning unnecessary range (step S106; NO), the controller 10 may calculate a difference ΔI between the measured peak intensity I and the target peak intensity I_{target} (step S107). Next, the controller 10 may drive the attenuation unit 62 to regulate the light intensity of the laser beam L1 that enters the spectrum detecting unit 63 so that the calculated difference ΔI becomes smaller (step S108). Subsequently, the controller 10 may check a position X of the variable attenuator (step S109). The position X of the variable attenuator may be calculated from a control amount given to the attenuation unit 62 or detected by a positioning sensor or the like installed in the movement mechanism.

Next, the controller 10 may determine whether or not the position X of the variable attenuator is within a usable range (X_{lower}<X<Xᵤₚₚₑᵣ) (step S110). If the variable attenuator is within the usable range (step S110; YES), the controller 10 may return to step S101 and execute the subsequent processings therefrom.

On the other hand, in the case where the variable attenuator is out of the usable range (step S110; NO), the controller 10 may determine that the peak intensity I cannot be controlled by the attenuation unit 62 (step S111). Next, the controller 10 may give a warning that the attenuation unit 62 cannot be tuned to an operator of the laser apparatus 100 or other members (step S112). Thereafter, the controller 10 may return to step S101 and execute the subsequent processings therefrom. In this manner, even in the case where the detected peak intensity of the laser beam L1 cannot be regulated so as to make it in a desired dynamic range, as long as the peak intensity is within a measurable range, the detected peak intensity is not treated as an error and the operation may be continued.

Meanwhile in the determination at step S105, if the peak intensity I of the laser beam L1 is not included in the predetermined dynamic range (step S105; NO), the controller 10 may determine that the peak intensity I is erroneous (step S113). Next, the controller 10 may stop the operation by interlock judging that the laser apparatus 100 is in an inoperable state (step S114). Thereafter, the controller 10 may stand by until the error disappears (step S115; NO). In this state, it is desirable to remove a cause of the error of the peak intensity I. An operator or other members may remove the cause of the error, or the controller 10 may operate individual components of the laser apparatus using a self-diagnostic function so as to find and remove the cause of the error. When it becomes possible to remove the error, the operator of the laser apparatus 100 or other members may input an error-removing signal to the controller 10 from exterior. Alternatively, the controller 10 itself may determine to remove the erroneous state based on drive information or the like held inside thereof. When the error has disappeared (step S115; YES), the controller 10 may release the interlock (step S116). Thereafter, the controller may return to step S101 and execute the subsequent processings therefrom. The operation shown in FIG. 2 may be appropriately terminated by an interrupt processing or the like from an exterior source.

### 3.4.2 Adjustment Oscillation Subroutine (Peak Intensity Regulation Included)

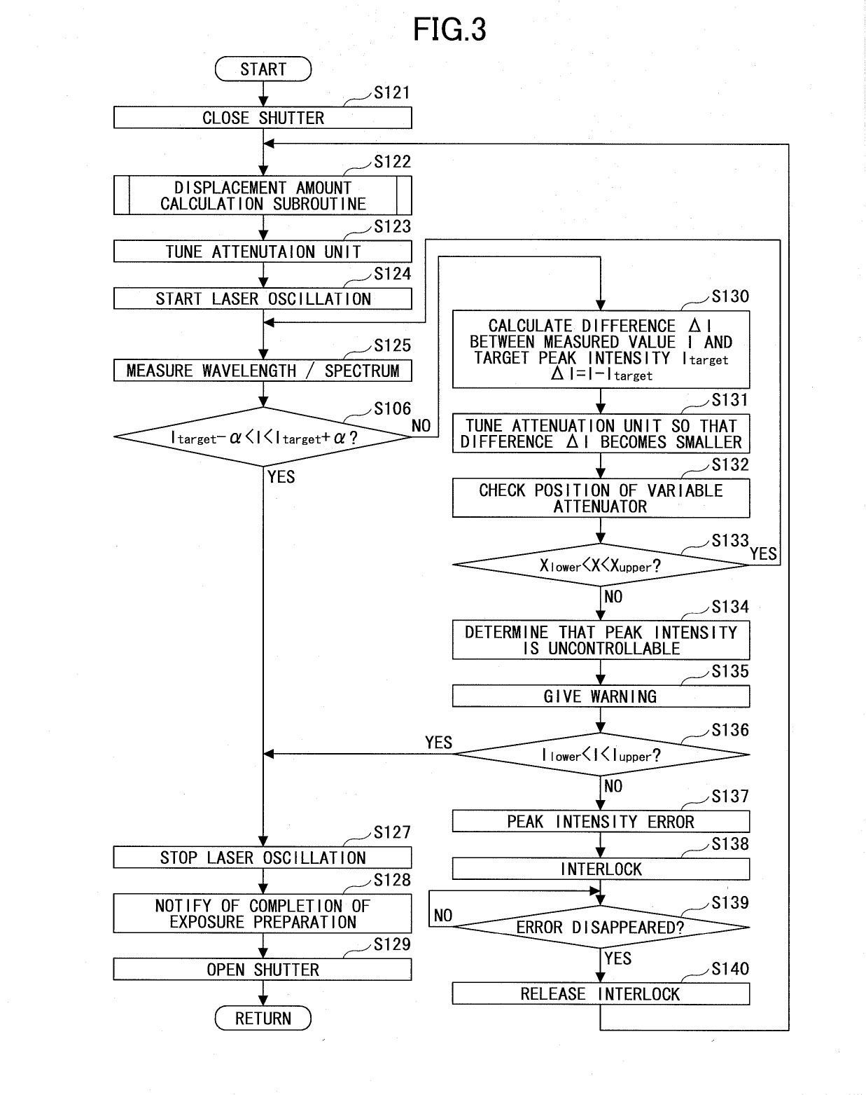

FIG. 3 illustrates an example of the adjustment oscillation subroutine indicated in step S102 of FIG. 2. As shown in FIG. 3, in the adjustment oscillation subroutine including peak intensity regulation of a laser beam L1, the controller 10 may first drive the shutter mechanism 70 to block the optical path of the laser beam L1 (step S121). Next, the controller 10 may execute a displacement amount calculation subroutine that estimates an amount of variation of the peak intensity I from an amount of change of the target spectral bandwidth αλt, and calculates an amount of displacement by the movement mechanism of the variable attenuator from the estimated peak intensity I (step S122). Subsequently, the controller 10 may tune the attenuation rate that is set by the attenuation unit 62 through giving the calculated displacement amount to the attenuation unit 62 (step S123).

Next, the controller 10 may make the master oscillator system 20 start an operation of laser oscillation in which the laser beam L1 is outputted at a predetermined repetition rate (step S124). At this time, the amplifying apparatus 50 may be driven as well. Subsequently, the controller 10 may measure a spectrum of the laser beam L1 outputted in step S124 using the spectral detector 60 (step S125). The spectrum measurement result may include information of the center wavelength λ and peak intensity I. Then, the controller 10 may determine whether or not the peak intensity I of the laser beam L1 is included in the attenuation-tuning unnecessary range (I_{target}−α<I<I_{target}+α) from the spectrum measurement result (step S126). This determination processing may be executed for each pulse or an average value of a plurality of pulses (for example, average value of 100 pulses or 1,000 pulses).

If the peak intensity I is within the attenuation-tuning unnecessary range (step S126; YES), the controller 10 may make the master oscillator system 20 stop the laser oscillation at the predetermined repetition rate (step S127). Next, the controller 10 may notify the exposure apparatus controller 81 of the completion of preparation for the exposure (step S128). Subsequently, the controller 10 may drive the shutter mechanism 70 to make the optical path of the laser beam L1 communicate with the exposure apparatus (step S129). Thereafter, the controller 10 may return to the operation shown in FIG. 2.

On the other hand, if the peak intensity I is out of the attenuation-tuning unnecessary range (step S126; NO), the controller 10 may calculate a difference ΔI between the measured peak intensity I and the target peak intensity I_{target} (step S130). Next, the controller 10 may drive the attenuation unit 62 to regulate the light intensity of the laser beam L1 that enters the spectrum detecting unit 63 so that the calculated difference ΔI becomes smaller (step S131). Subsequently, the controller 10 may check a position X of the variable attenuator (step S132). The position X of the variable attenuator may be calculated from a control amount given to the attenuation unit 62 or detected by the positioning sensor or the like installed in the movement mechanism.

Next, the controller 10 may determine whether or not the position X of the variable attenuator is within the usable range (X_{lower}<X<Xᵤₚₚₑᵣ) (step S133). If the variable attenuator is within the usable range (step S133; YES), the controller 10 may return to step S125 and execute the subsequent processings therefrom.

On the other hand, in the case where the variable attenuator is out of the usable range (step S133; NO), the controller 10 may determine that the peak intensity I cannot be controlled by the attenuation unit 62 (step S134). Next, the controller 10 may give a warning that the attenuation unit 62 cannot be tuned to the operator of the laser apparatus 100 or other members (step S135).

Next, the controller 10 may determine from the spectrum measurement result obtained in step S125 whether or not the peak intensity I of the laser beam I is included in the predetermined dynamic range (I_{lower}<I<Iᵤₚₚₑᵣ) (step S136). If the peak intensity I of the laser beam L1 is included within the predetermined dynamic range (step S136; YES), the controller 10 may go to step S127 and execute the subsequent processings therefrom.

On the other hand, if the peak intensity I of the laser beam L1 is not included in the predetermined dynamic range (step S136; NO), the controller 10 may determine that the peak intensity I is erroneous (step S137). Next, the controller 10 may stop the operation by the interlock judging that the laser apparatus 100 is in an inappropriate operation state (step S138). Thereafter, the controller 10 may stand by until the error disappears (step S139; NO). In this state, it is desirable to remove a cause of the error of the peak intensity I. The operator or other members may remove the cause of the error, or the controller 10 may operate the individual components of the laser apparatus using the self-diagnostic function so as to find and remove the cause of the error. When it becomes possible to remove the error, the operator of the laser apparatus 100 or other members may input a signal for removing the error from exterior, or the controller 10 itself may determine to remove the error based on the drive information or the like held inside thereof. When the error has disappeared (step S139; YES), the controller 10 may release the interlock (step S140). Thereafter, the controller 10 may return to step S122 and execute the subsequent processings therefrom.

### 3.4.3 Displacement Amount Calculation Subroutine

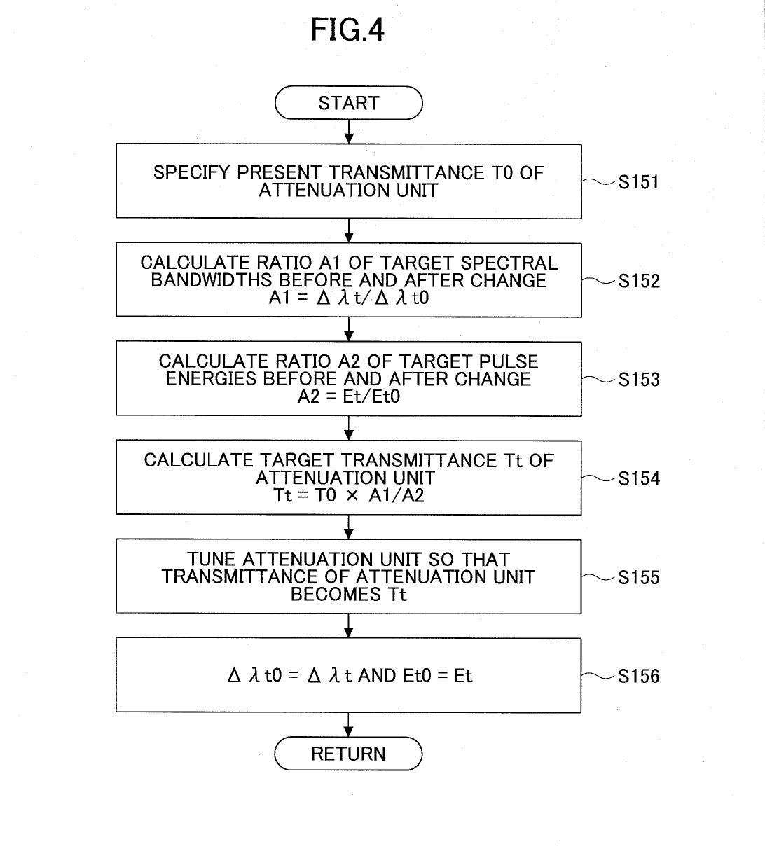

FIG. 4 illustrates an example of the displacement amount calculation subroutine indicated in step S122 of FIG. 3. In the displacement amount calculation subroutine, as shown in FIG. 4, the controller 10 may first specify a present transmittance T0 of the attenuation unit 62 (step S151). The controller 10 may obtain the present transmittance T0 of the attenuation unit 62 by referring to a table in which a present position X of the variable attenuator is related to the present transmittance T0, for example; note that the table may be stored in the storage unit 11. Alternatively, a present distribution characteristic of transmittance of the variable attenuator (dependent on a position) maybe stored in the storage unit 11 in form of a calculating formula in advance, for example; then the controller 10 may obtain the transmittance T0 as a calculation result through inputting the position X into this calculating formula.

Next, the controller 10 may calculate a ratio A1 of target spectral bandwidths before and after the change thereof (step S152). The ratio A1 is calculated by a formula A1=Δλt/Δλt0, where Δλt0 is a target spectral bandwidth before the change and Δλt is a target spectral bandwidth after the change. Further, the controller 10 may calculate a ratio A2 of target pulse energies before and after the change thereof (step S153). The ratio A2 may be calculated by a formula A2=Et/Et0, where Et0 is a target pulse energy before the change and Et is a target pulse energy after the change.

Next, the controller 10 may calculate a target transmittance Tt of the attenuation unit 62 from the calculated ratios A1 and A2 (step S154). The target transmittance Tt may be calculated by a formula Tt=T0×(A1/A2), for example.

Then, the controller 10 may tune the attenuation unit 62 so that the transmittance of the attenuation unit 62 becomes the target transmittance Tt (step S155). Subsequently, the controller 10 may substitute the target spectral bandwidth after the change Δλt for the present target spectral bandwidth Δλt0 (Δλt0=Δλt), and also substitute the target pulse energy after the change Et for the present target pulse energy Et0 (Et0=Et) (step S156). Thereafter, the controller 10 may return to the operation shown in FIG. 3.

Through the operations described above, the peak intensity of a laser beam L1 that enters the spectrum detecting unit 63 can be regulated so as to fall within a predetermined dynamic range. As a result, the spectral bandwidth of the laser beam L1 can be measured more accurately. This makes it possible to tune the spectral bandwidth of the laser beam L1 to a target spectral bandwidth in a more stabilized manner.

### 4. Variable Attenuator

Hereinafter, specific examples of the attenuation unit 62 according to the above-described embodiment will be explained.

### 4.1 Rotation-Type Variable Attenuator

FIG. 5 illustrates an example of a spectral detector that includes an attenuation unit using a rotation-type variable attenuator. FIG. 6 illustrates an example of the configuration of a variable attenuator 621 shown in FIG. 5 when viewed from an incident direction of a laser beam L1.

As shown in FIG. 5, a spectral detector 60A may include the beam splitter 61, an attenuation unit 620, the spectrum detecting unit 63, and a beam dumper 64. The attenuation unit 620 may include the variable attenuator 621 and a movement mechanism 622.

As shown in FIG. 6, the variable attenuator 621 may be formed in a rotary disk shape. The movement mechanism 622 may rotate the variable attenuator 621. The transmittance of the variable attenuator 621 may vary depending on a position along a rotational direction of the attenuator. For example, the variable attenuator 621 may have a configuration in which thickness thereof varies depending on a position along the rotational direction; or it may have a configuration in which application concentration of a reflecting or shielding film or thickness of the film varies depending on a position along the rotational direction. This makes it possible for the transmittance to vary depending on a position along the rotational direction.

A laser beam L1 split by the beam splitter 61 may enter the variable attenuator 621 of the attenuation unit 620. The variable attenuator 621 maybe tilted relative to an incident axis of the laser beam L1. The movement mechanism 622 may change the incident position of the laser beam L1 on the variable attenuator 621 by rotating the variable attenuator 621 under the instruction of the controller 10. In this description, an amount of rotation of the variable attenuator 621 corresponds to an amount of displacement from a present position or a reference position of the attenuator. The movement mechanism 622 may rotate the variable attenuator 621 without changing the incident angle of the laser beam L1. A clean motor, an ultrasonic motor or the like that is capable of suppressing generation of contaminants may be used in the movement mechanism 622.

The laser beam L1 that has passed through the variable attenuator 621 may enter the spectrum detecting unit 63. The spectrum detecting unit 63 may measure a spectrum of the attenuated laser beam L1. The measurement result of the spectrum maybe inputted to the controller 10.

The laser beam L1 that has reflected off the variable attenuator 621 may be incident on the beam dumper 64. The beam dumper 64 may absorb the incident laser beam L1. A cooling system (not shown) may be installed in the beam dumper 64.

### 4.2 Slide-Type Variable Attenuator

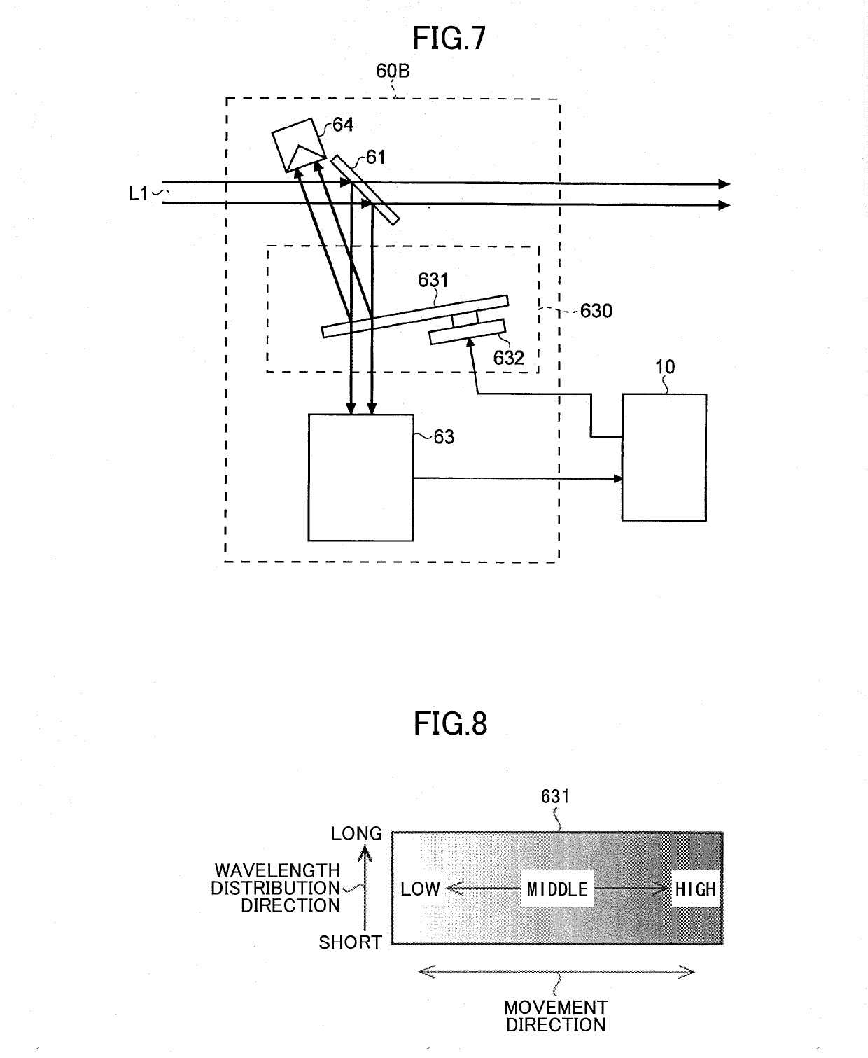

FIG. 7 illustrates an example of a spectral detector that includes an attenuation unit using a slide-type variable attenuator. FIG. 8 illustrates an example of a configuration of a variable attenuator 631 shown in FIG. 7 when viewed from the incident direction of a laser beam L1.

As shown in FIG. 7, a spectral detector 60B may have a configuration that is similar to that of the spectral detector 60A shown in FIG. 5, and in which the attenuation unit 620 is replaced with an attenuation unit 630. The attenuation unit 630 may include the variable attenuator 631 and a movement mechanism 632.

The variable attenuator 631 may be formed in a rectangular plate shape as shown in FIG. 8. The movement mechanism 632 may slide the variable attenuator 631. The transmittance of the variable attenuator 631 may vary depending on a position along a sliding direction of the attenuator. For example, the variable attenuator 631 may have a configuration in which thickness thereof varies depending on a position along the sliding direction; or it may have a configuration in which application concentration of a reflecting or shielding film or thickness of the film varies depending on a position along the sliding direction. This makes it possible for the transmittance to vary depending on a position along the sliding direction.

The laser beam L1 split by the beam splitter 61 may enter the variable attenuator 631 of the attenuation unit 630. The variable attenuator 631 may be tilted relative to the incident axis of the laser beam L1. The movement mechanism 632 may change the incident position of the laser beam L1 on the variable attenuator 631 by sliding the variable attenuator 631 under the instruction of the controller 10. In this description, an amount of sliding of the variable attenuator 631 corresponds to an amount of displacement from a present position or a reference position of the attenuator. The movement mechanism 632 may slide the variable attenuator 631 without changing the incident angle of the laser beam L1. A clean motor, an ultrasonic motor or the like that is capable of suppressing generation of contaminants may be used in the movement mechanism 632.

The laser beam L1 that has passed through the variable attenuator 631 may enter the spectrum detecting unit 63. The laser beam L1 that has reflected off the variable attenuator 631 may be incident on the beam dumper 64.

### 4.3 Incident Angle Adjusting-Type Variable Attenuator

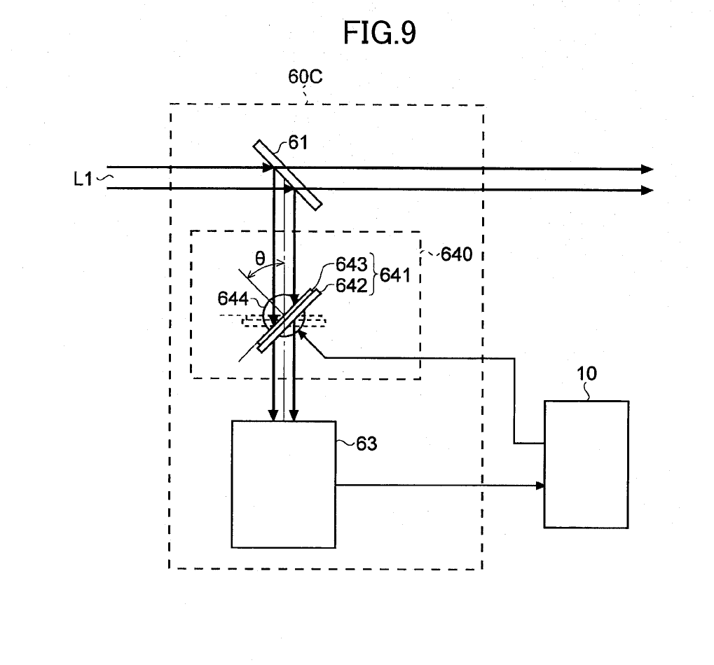

FIG. 9 illustrates an example of a spectral detector that includes an attenuation unit using an incident angle adjusting-type variable attenuator.

As shown in FIG. 9, a spectral detector 60C may have a configuration that is similar to that of the spectral detector 60A shown in FIG. 5, and in which the attenuation unit 620 in FIG. 5 is replaced with an attenuation unit 640. The attenuation unit 640 may include a variable attenuator 641 and a rotation mechanism 644.

The variable attenuator 641 may include a transparent substrate 642 and a dielectric multilayer film 643. The transparent substrate 642 may transmit a laser beam L1. The dielectric multilayer film 643 may be formed on a surface of the transparent substrate 642 on which the laser beam L1 is incident. The dielectric multilayer film 643 may have a position-independent uniform reflectance. However, the dielectric multilayer film 643 may be configured so that the transmittance thereof varies depending on an incident angle of the laser beam L1. The rotation mechanism 644 may rotate the variable attenuator 641 so as to change an incident angle e of the laser beam L1. Through this, the transmittance can be varied depending on the incident angle θ of the laser beam L1.

The laser beam L1 split by the beam splitter 61 may enter the variable attenuator 641 of the attenuation unit 640. The rotation mechanism 644 may change the incident angle θ of the laser beam L1 to the variable attenuator 641 by changing the tilt of the incident surface of the variable attenuator 641 under the instruction of the controller 10. In this description, an amount of change in the tilt of the incident surface of the variable attenuator 641 corresponds to an amount of displacement from a present position or a reference position of the attenuator. A clean motor, an ultrasonic motor or the like that is capable of suppressing generation of contaminants may be used in the rotation mechanism 644.

The laser beam L1 that has passed through the variable attenuator 641 may enter the spectrum detecting unit 63. The laser beam L1 that has reflected off the variable attenuator 641 may be incident on a beam dumper (not shown).

### 4.4 Incident Angle Adjusting-type Variable Attenuator (Variation)

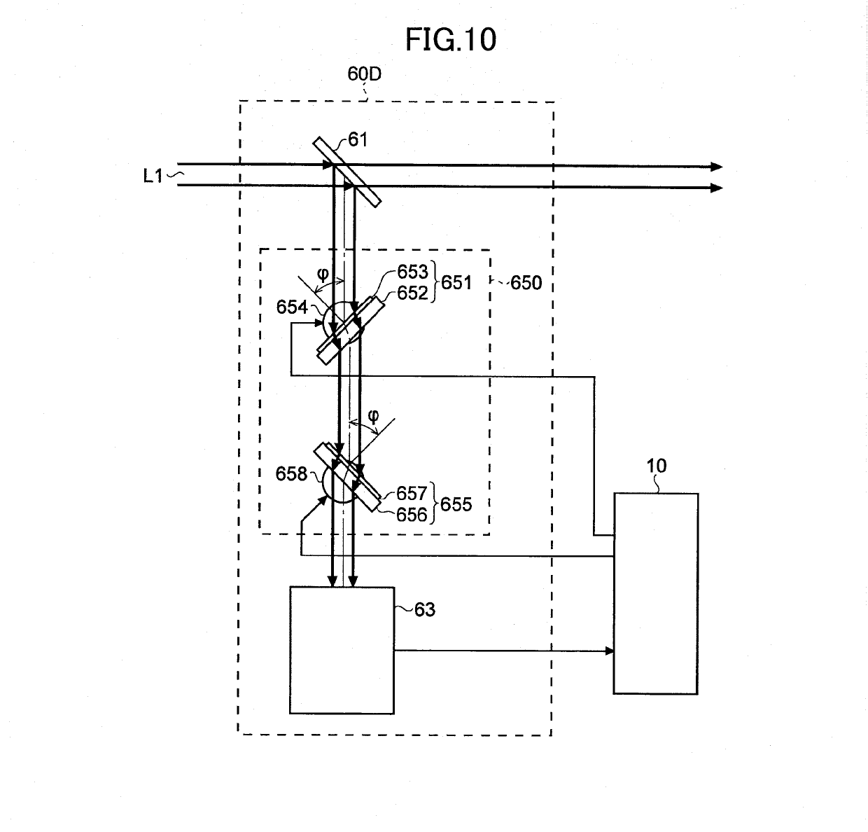

FIG. 10 illustrates another example of a spectral detector that includes an attenuation unit using an incident angle adjusting-type variable attenuator.

As shown in FIG. 10, a spectral detector 60D may have a configuration that is similar to that of the spectral detector 60C shown in FIG. 9, and in which the attenuation unit 640 in FIG. 9 is replaced with an attenuation unit 650. The attenuation unit 650 may include variable attenuators 651, 655 and rotation mechanisms 654, 658.

The variable attenuator 651, like the variable attenuator 641, may include a transparent substrate 652 and a dielectric multilayer film 653. The transparent substrate 652 may transmit a laser beam L1. The dielectric multilayer film 653 may be formed on a surface of the transparent substrate 652 on which the laser beam L1 is incident. The dielectric multilayer film 653 may have a position-independent uniform reflectance. However, the dielectric multilayer film 653 may be configured so that the transmittance thereof varies depending on an incident angle of the laser beam L1. The rotation mechanism 654 may rotate the variable attenuator 651 so as to change an incident angle φ of the laser beam L1. Through this, the transmittance can be varied depending on the incident angle φ of the laser beam L1.

The variable attenuator 655, like the variable attenuator 651, may include a transparent substrate 656 and a dielectric multilayer film 657. The rotation mechanism 658 may have the same configuration as the rotation mechanism 654. A clean motor, an ultrasonic motor or the like that is capable of suppressing generation of contaminants may be used in each of the rotation mechanisms 654 and 658.

The laser beam L1 split by the beam splitter 61 may enter the variable attenuator 651 of the attenuation unit 650. The rotation mechanism 654 may change an incident angle φ of the laser beam L1 to the variable attenuator 651 by changing the tilt of the incident surface of the variable attenuator 651 under the instruction of the controller 10.

The laser beam L1 that has passed through the variable attenuator 651 may enter the variable attenuator 655. The rotation mechanism 658 may change the incident angle φ of the laser beam L1 to the variable attenuator 655 by changing the tilt of the incident surface of the variable attenuator 655 under the instruction of the controller 10.

An amount of rotation (amount of displacement) of the variable attenuator 651 by the rotation mechanism 654 may be equal to an amount of rotation (amount of displacement) of the variable attenuator 655 by the rotation mechanism 658. Note that the rotation mechanism 658 may change the tilt of the variable attenuator 655 in the rotational direction opposite to that in the case of the rotation mechanism 654. Through this, deviation of the optical axis or the optical path of the laser beam L1 caused by the laser beam L1 passing through the variable attenuator 651 can be lessened.

The laser beam L1 that has passed through the variable attenuator 655 may enter the spectrum detecting unit 63. The laser beam L1 that has reflected off the variable attenuator 651 or 655 may be incident on a beam dumper (not shown).

### 5. Spectral Detector Including Variable Attenuator

Next, another example of the spectral detector 60 according to the aforementioned embodiments will be specifically described hereinafter. Note that a configuration based on the spectral detector 60A shown in FIG. 5 is exemplified below. However, the configuration of the invention is not limited thereto, and a configuration based on any of the other spectral detectors 60B through 60D may be employed instead.

### 5.1 Configuration

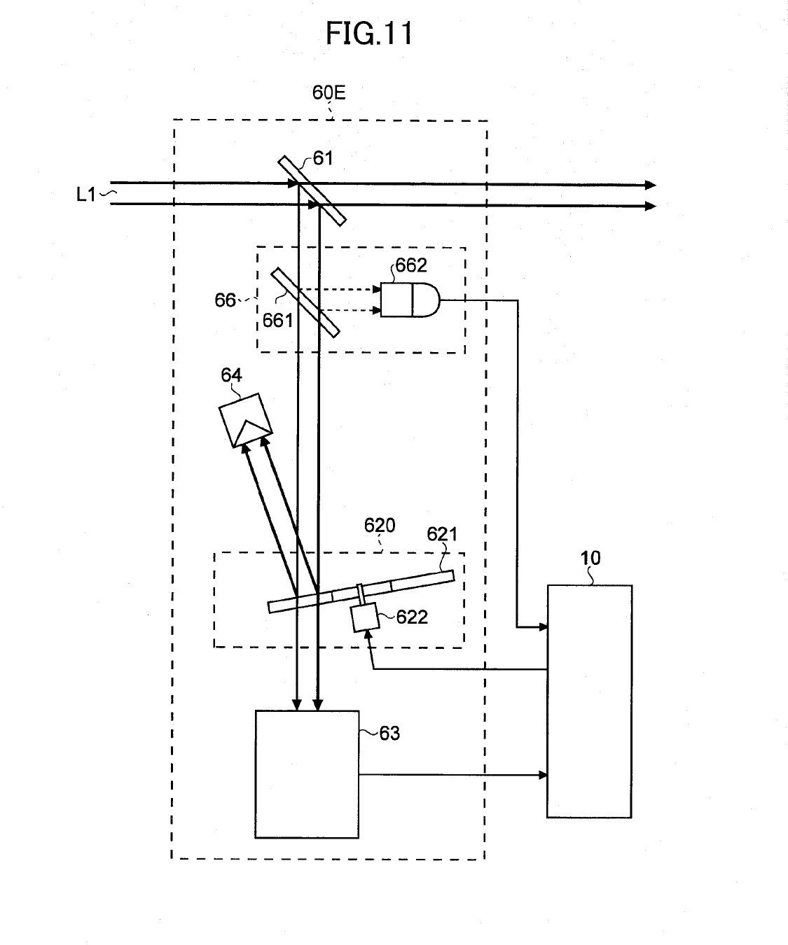

FIG. 11 illustrates an example of a spectral detector 60E that includes an attenuation unit using a variable attenuator. As shown in FIG. 11, the spectral detector 60E may further include an energy detector 66 in addition to a configuration similar to that of the spectral detector 60A shown in FIG. 5. The energy detector 66 may be disposed on an optical path of a laser beam L1 split by the beam splitter 61. The energy detector 66 may be disposed at a location that is closer to an input side of the laser beam L1 than to the attenuation unit 620. The energy detector 66 may include a beam splitter 661 and an energy sensor 662.

### 5.2 Operations

The laser beam L1 split by the beam splitter 61 may be further split by the beam splitter 661 of the energy detector 66. The laser beam L1 split by the beam splitter 661 may be incident on the energy sensor 662. The energy sensor 662 may detect energy of the laser beam L1 split by the beam splitter 661. The energy sensor 662 may input the detection result of the energy to the controller 10. The controller 10 may tune an attenuation rate set by the attenuation unit 620 based on the detection result of the energy having been inputted thereto.

### 5.3 Effect

Because the energy detector 66 for detecting pulse energy of a laser beam L1 is provided in the spectral detector, it is possible to regulate the peak intensity of the laser beam L1 based on an energy detection result in addition to a spectrum measurement result. This in turn may increase a processing speed of operation in some case.

### 6. Wave-Front Tuning Mechanism

Next, the wave-front tuning unit 22 in the master oscillator system 20 according to the aforementioned embodiment will be described hereinafter using some examples.

6.1 Wave-Front Tuning Mechanism Separated from Output Coupling Mirror

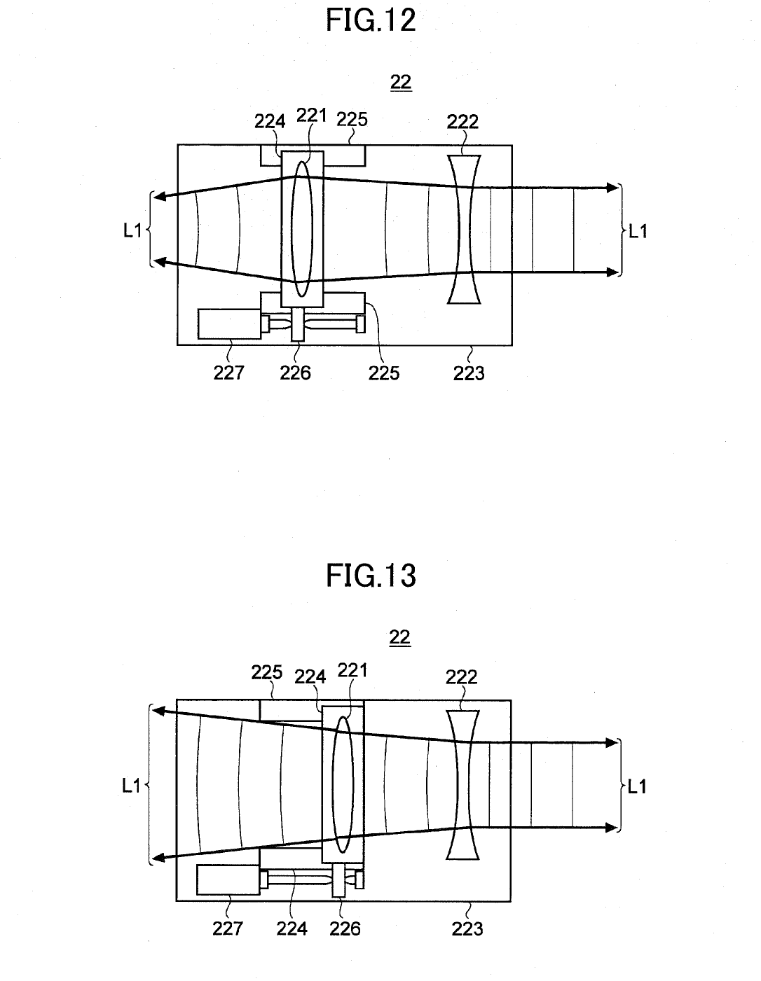

FIG. 12 and FIG. 13 illustrate an example of the configuration of the wave-front tuning unit 22. The wave-front tuning unit 22 may include a concave cylindrical lens 222 both surfaces of which are recessed in a semi-cylindrical manner, a convex cylindrical lens 221 both surfaces of which are projected in a semi-cylindrical manner, and a rest 223. The concave cylindrical lens 222 or the convex cylindrical lens 221 may be equipped with a movement mechanism that moves the lens along the optical axis of a laser beam L1. In this description, the convex cylindrical lens 221 is equipped with the movement mechanism. The concave cylindrical lens 222, which is not equipped with the movement mechanism, may be anchored to the rest 223.

The movement mechanism may include, for example, a movement stage 224, a slide rail 225, a projection 226, and a stepping motor 227. The convex cylindrical lens 221 may be anchored to the movement stage 224. The slide rail 225 may be anchored to the rest 223 so that it extends along the optical path of the laser beam L1. The movement stage 224 may be mounted on the slide rail 225 in a slidable manner. The projection 226 may stick out from the movement stage 224. The stepping motor 227 may move the projection 226 back and forth along the extension direction of the slide rail 225. A shaft connected to the stepping motor 227 may make contact with the projection 226, and the projection 226 may be pushed to the shaft from the opposite side to the shaft with a plunger pin or the like. The projection 226 may be pushed/pulled by driving the stepping motor 227. Through this, the convex cylindrical lens 221 on the movement stage 224 may be moved along the optical path of the laser beam L1. As a result, a distance between the convex cylindrical lens 221 and the concave cylindrical lens 222 may be adjusted.

As shown in FIGS. 12 and 13, the wave-front tuning unit 22 having the above-described configuration can tune the wave-front of the laser beam L1 by adjusting the distance between the concave cylindrical lens 222 and the convex cylindrical lens 221.

6.2 Wave-Front Tuning Mechanism Integrated with Output Coupling Mirror

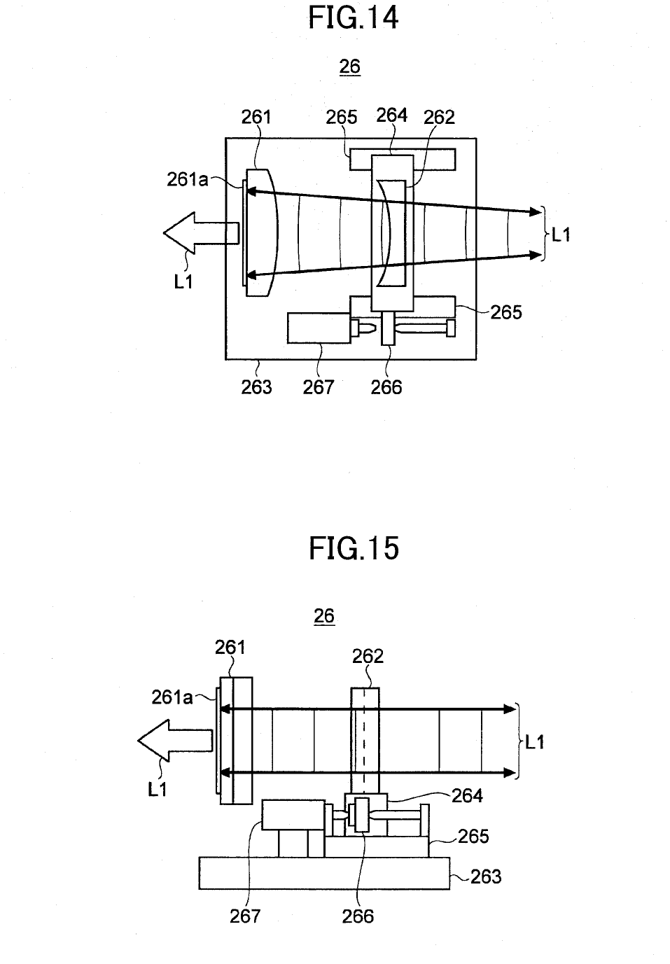

The wave-front tuning unit 22 and the output coupling mirror 21 may be replaced with a wave-front tuning unit 26 having both the functions of the wave-front tuning unit 22 and the output coupling mirror 21. FIGS. 14 and 15 illustrate an example of the configuration of the wave-front tuning unit 26. FIG. 14 is a top view of the wave-front tuning unit 26, and FIG. 15 is a side view of the wave-front tuning unit 26.

The wave-front tuning unit 26 may include a convex cylindrical lens 261 one surface of which is projected in a semi-cylindrical manner, a concave cylindrical lens 262 one surface of which is recessed in a semi-cylindrical manner, and a rest 263. The concave cylindrical lens 262 may be equipped with a movement mechanism that moves the lens along the optical axis of a laser beam L1. The convex cylindrical lens 261 may be anchored to the rest 263. A partial reflection coat 261a may be provided on a surface of the convex cylindrical lens 261 at the opposite side to the curved surface side of the lens. The surface where the partial reflection coat 261a is formed may function as a laser output terminal of the master oscillator system 20.

The movement mechanism may include, for example, a movement stage 264, a slide rail 265, a projection 266, and a stepping motor 267. The concave cylindrical lens 262 maybe anchored to the movement stage 264. The slide rail 265 may be anchored to the rest 263 so that it extends along the optical path of the laser beam L1. The movement stage 264 may be mounted on the slide rail 265 in a slidable manner. The projection 266 may stick out from the movement stage 264. The stepping motor 267 may move the projection 266 back and forth along the extension direction of the slide rail 265. A shaft connected to the stepping motor 267 may make contact with the projection 266, and the projection 266 may be pushed to the shaft from the opposite side to the shaft with a plunger pin or the like. The projection 266 may be pushed/pulled by driving the stepping motor 267. Through this, the concave cylindrical lens 262 on the movement stage 264 may be moved along the optical path of the laser beam L1. As a result, a distance between the concave cylindrical lens 262 and the convex cylindrical lens 261 may be adjusted.

As shown in FIGS. 14 and 15, the wave-front tuning unit 26 having the configuration described above can tune the wave-front of a laser beam L1 by adjusting the distance between the convex cylindrical lens 261 and the concave cylindrical lens 262.

### 7. Magnification Adjusting Unit

Hereinafter, the magnification adjusting unit 32 in the master oscillator system 20 according to the aforementioned embodiment will be described using some examples.

### 7.1 Magnification Adjusting Unit Including Prism Switching Mechanism

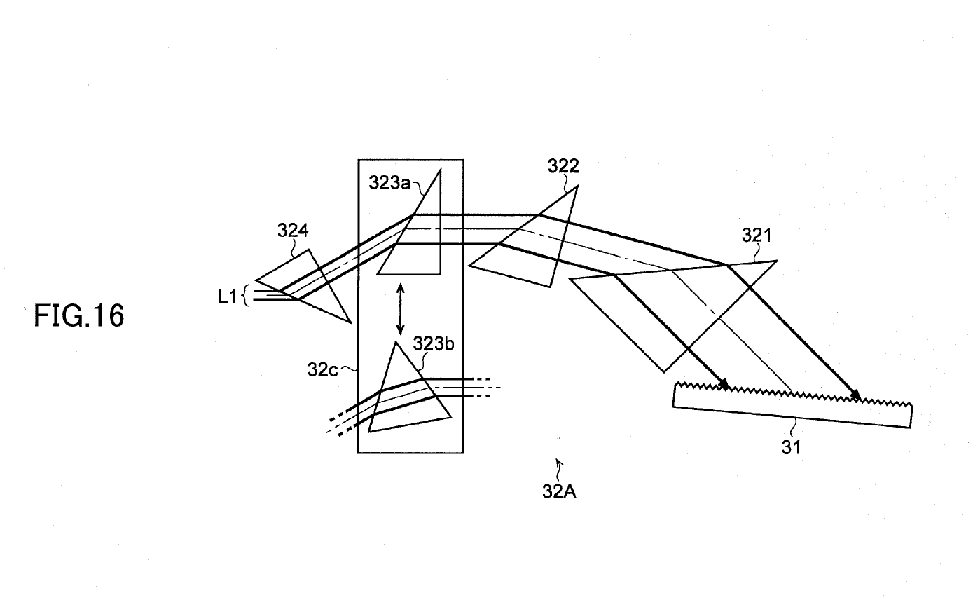

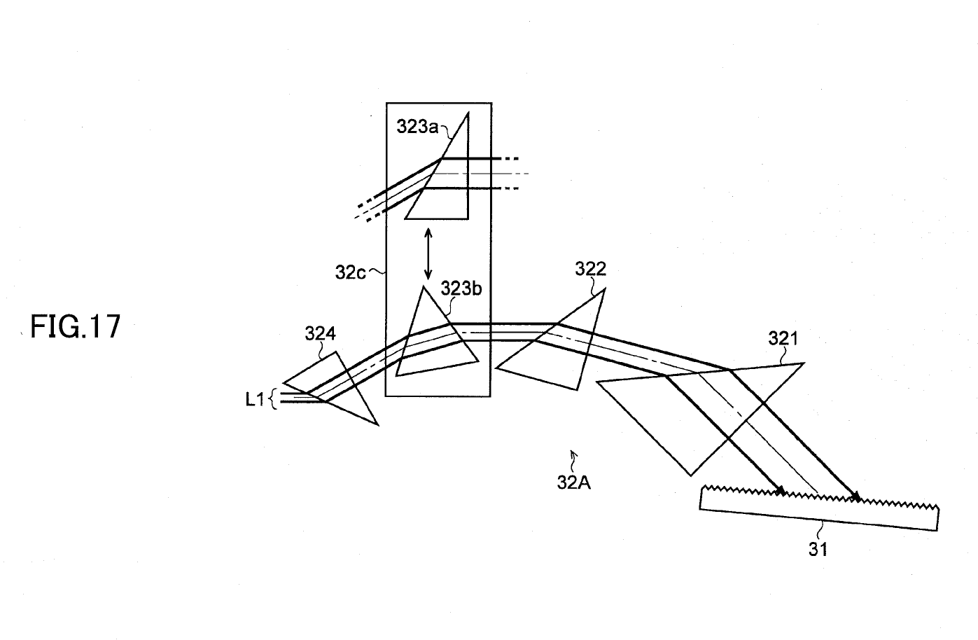

FIG. 16 and FIG. 17 illustrate an example of a magnification adjusting unit 32A including a mechanism for switching at least one of plural prisms.

As shown in FIGS. 16 and 17, the magnification adjusting unit 32A may include a plurality of prisms 321, 322, 323a, 323b, and 324. Among these prisms, the prisms 323a and 323b may be switchable with respect to an optical path of a laser beam L1. FIG. 16 illustrates a case where the prism 323a is arranged on the optical path, while FIG. 17 illustrates a case where the prism 323b is arranged on the optical path.

The laser beam L1 that enters the prism 323a from a front edge side (laser output terminal) may be emitted along the same optical axis as that of the laser beam L1 that enters the prism 323b in the same manner from the front edge side (laser output terminal). However, it is preferable for the beam diameter of the laser beam L1 emitted from the prism 323a to be different from that of the laser beam L1 emitted from the prism 323b.

The prisms 323a and 323b may be mounted on a movement stage 32c. The magnification adjusting unit 32A may selectively arrange either the prism 323a or 323b on the optical path of the laser beam L1 by the movement mechanism 32c that is connected to a driving mechanism (not shown). With this, the beam diameter of the laser beam L1 that enters the grating 31 can be changed corresponding to the respective magnification rates set on the prism 323a and the prism 323b.

### 7.2 Magnification Adjusting Unit Including Prism Rotation Mechanism

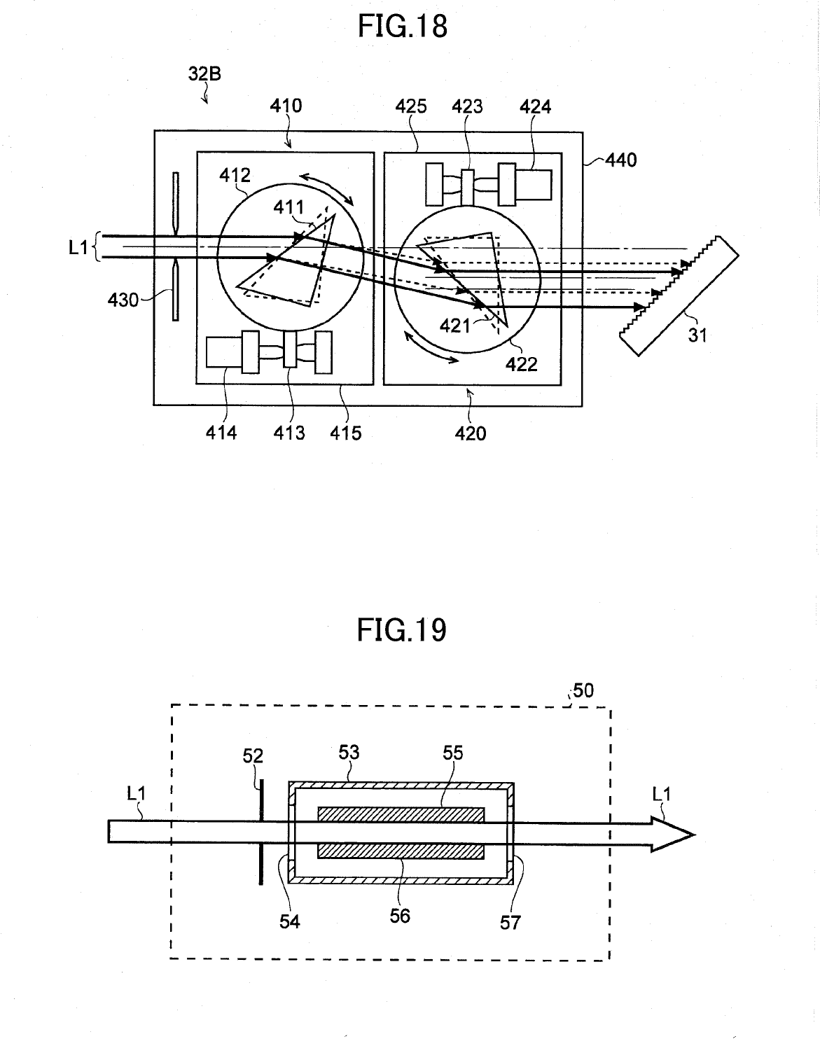

In the case where a magnification adjusting unit is configured using a plurality of prisms, it is possible to control the beam diameter through adjusting the optical path by rotating each prism. FIG. 18 illustrates an example of a magnification adjusting unit 32B that includes a plurality of prisms held in a rotatable manner.

As shown in FIG. 18, the magnification adjusting unit 32B may include optical path adjusting units 410 and 420, a pinhole 430, and a rest 440. The optical path adjusting units 410, 420 and the pinhole 430 may be anchored to the rest 440.

The pinhole 430 may be arranged on the front edge side (laser output terminal side) of the magnification adjusting unit 32. The pinhole 430 may reform the beam cross-section of a laser beam L1 passing therethrough.

The optical path adjusting unit 410 may include a prism 411, a rotational plate 412, a projection 413, a stepping motor 414, and a stage 415. The prism 411 may be anchored on the rotational plate 412. The rotational plate 412 may be held on the stage 415 in a rotatable manner. The projection 413 may be provided on the circumference of the rotational plate 412. A shaft connected to the stepping motor 414 may make contact with the projection 413, and the projection 413 maybe pushed to the shaft from the opposite side to the shaft with a plunger pin or the like. The projection 413 may be pushed/pulled by driving the stepping motor 414, thereby making it possible for the prism 411 to rotate.

Likewise, the optical path adjusting unit 420 may include a prism 421, a rotational plate 422, a projection 423, a stepping motor 424, and a stage 425. The prism 421 may be anchored on the rotational plate 422. The rotational plate 422 may be held on the stage 425 in a rotatable manner. The projection 423 may be provided on the circumference of the rotational plate 422. A shaft connected to the stepping motor 424 may make contact with the projection 423, and the projection 423 may be pushed to the shaft from the opposite side to the shaft with a plunger pin or the like. The projection 423 may be pushed/pulled by driving the stepping motor 424, thereby making it possible for the prism 421 to rotate.

The beam diameter of a laser beam L1 that passes through the magnification adjusting unit 32 may change based on the magnification rates that are dependent on the tilts of the prisms 411 and 412 relative to the optical axis of the laser beam L1. The optical path adjusting unit 420 may adjust the optical axis of the laser beam L1 so that the optical axis thereof, which is deviated from the original optical axis by the optical path adjusting unit 410, comes to be parallel to the original optical path. The stepping motors 414 and 424 may respectively rotate the rotational plates 412 and 422 under the control from the controller 10.

### 8. Amplifying Apparatus

Next, the amplifying apparatus 50 shown in FIG. 1 will be described in detail with reference to the drawings. The amplifying apparatus 50 may be various kinds of apparatuses such as a power oscillator, a power amplifier, a regenerative amplifier and so on. In addition, the amplifying apparatus 50 may be a single amplifying apparatus or may include a plurality of amplifying apparatuses.

8.1 Power Amplifier with Excimer Gas as Gain Medium

FIG. 19 schematically illustrates a general configuration of the amplifying apparatus 50 configured as a power amplifier. As shown in FIG. 19, the amplifying apparatus 50 may include a chamber 53, and may further include a slit 52 for adjusting the beam profile of a laser beam L1. Windows 54 and 57 may be provided in the chamber 53. The windows 54 and 57 may pass a laser beam L1 while maintaining air tightness of the chamber 53. The interior of the chamber 53 may be filled with a gain medium such as an excimer gas or the like. The gain medium may include at least one of Kr, Ar, F₂, Ne and Xe gases, for example. Further, a pair of discharge electrodes 55, 56 may be provided within the chamber 53. The discharge electrodes 55, 56 may be arranged sandwiching a region (amplification region) through which the laser beam L1 passes. Pulsed high voltage may be applied between the discharge electrodes 55 and 56 from a power supply (not shown). The high voltage may be applied between the discharge electrodes 55 and 56 at a timing when the laser beam L1 passes through the amplification region. When the high voltage is applied between the discharge electrodes 55 and 56, an amplification region including an activated gain medium can be formed between the discharge electrodes 55 and 56. The laser beam L1 can be amplified when passing through this amplification region.

8.2 Power Oscillator with Excimer Gas as Gain Medium

Next, examples in which a power oscillator is used as the amplifying apparatus 50 will be described below.

### 8.2.1 Embodiment Including Fabry-Perot Resonator

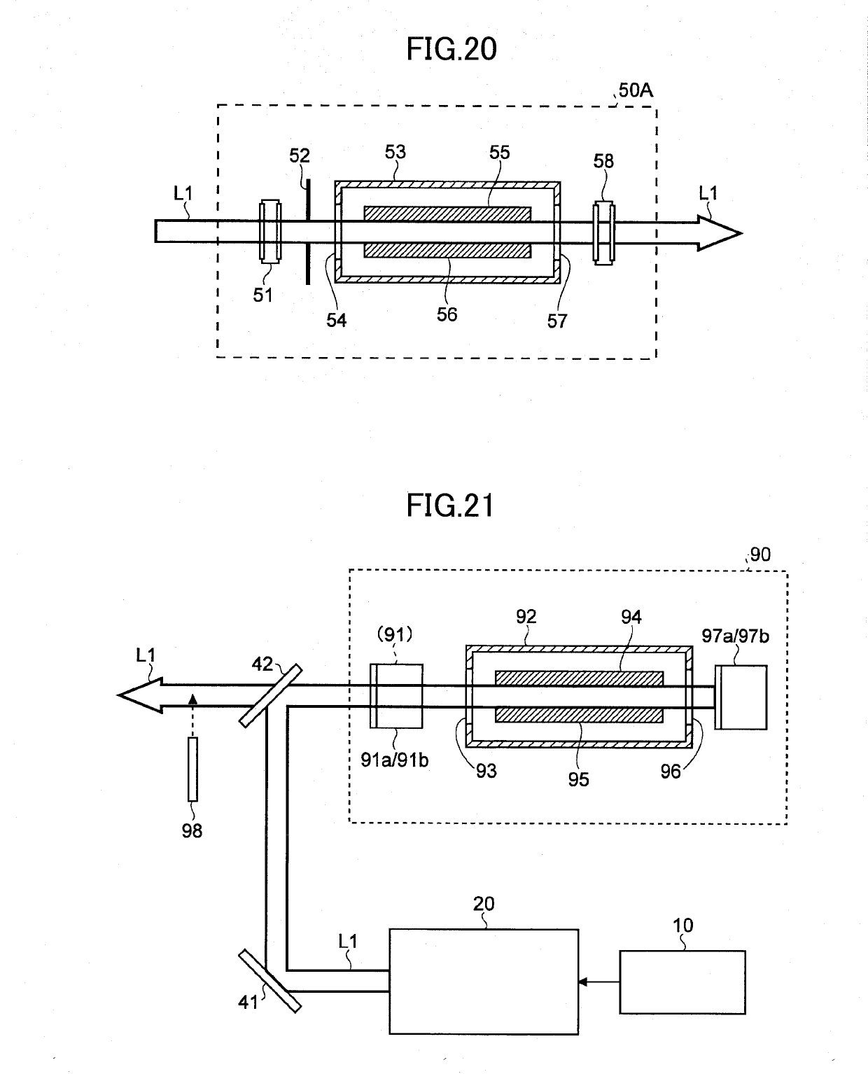

First, an example in which a power oscillator equipped with a Fabry-Perot resonator is used as the amplifying apparatus 50 is described. FIG. 20 schematically illustrates a general configuration of an amplifying apparatus 50A using a power oscillator equipped with a Fabry-Perot resonator. As shown in FIG. 20, the amplifying apparatus 50A may include a rear mirror 51 that reflects a part of a laser beam and transmits another part of the laser beam and an output coupler 58 that reflects a part of a laser beam and transmits another part of the laser beam, in addition to the same configuration in the amplifying apparatus 50 shown in FIG. 19. The rear mirror 51 and the output coupler 58 may form an optical resonator. Note that it is preferable for the reflectance of the rear mirror 51 to be higher than that of the output coupler 58. The output coupler 58 may be an output terminal for the laser beam L1 that has been amplified.

### 8.2.2 Embodiment Including Ring Resonator

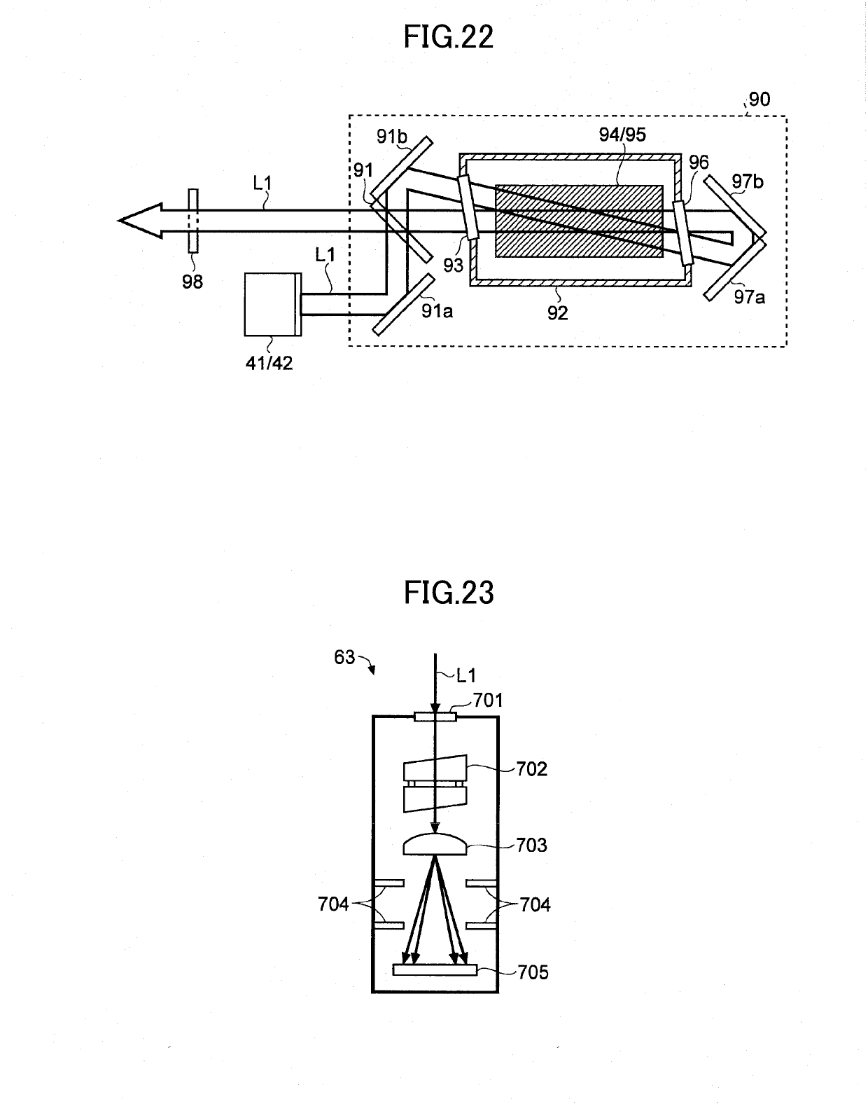

Next, an example in which a power oscillator equipped with a ring resonator is used as the amplifying apparatus 50 is described. FIG. 21 and FIG. 22 schematically illustrate a general configuration of an amplifying apparatus 90 using a power oscillator equipped with a ring resonator. FIG. 21 is a side view of the amplifying apparatus 90, and FIG. 22 is a top view thereof. A shutter 98 that blocks a laser beam L1 outputted from the amplifying apparatus 90 may be further provided in an output stage of the amplifying apparatus 90. The shutter 98 may also serve as the shutter 71 mentioned earlier.

As shown in FIGS. 21 and 22, the amplifying apparatus 90 may include highly reflective mirrors 91a, 91b, 97a and 97b, an output coupler 91, and a chamber 92. The output coupler 91 and the highly reflective mirrors 91a, 91b, 97a and 97b may form a multipass optical path on which the laser beam L1 passes a plurality of times in an amplification region within the chamber 92. The output coupler 91 may be a partial reflection mirror. The chamber 92 may be arranged on the optical path formed by the output coupler 91 and the highly reflective mirrors 91a, 91b, 97a and 97b. Further, the amplifying apparatus 90 may include a slit (not shown) for adjusting the beam profile of the laser beam L1 that travels inside thereof. The interior of the chamber 92 may be filled with a gain medium such as an excimer gas or the like so that the amplification region is filled with the gain medium. The gain medium may include at least one of Kr, Ar, F₂, Ne and Xe gases, for example.

In the above configuration, the laser beam L1 outputted from the master oscillator system 20 may enter the amplifying apparatus 90 via highly reflective mirrors 41 and 42, for example. The laser beam L1 having entered the apparatus may be reflected by the highly reflective mirrors 91a and 91b first, then enter the chamber 92 via a window 93. The laser beam L1 having entered the chamber 92 may be amplified when passing through the amplification region between two discharge electrodes 94 and 95 where voltage is being applied therebetween. The amplified laser beam L1 may be emitted from the chamber 92 via a window 96. The emitted laser beam L1 may be reflected by the highly reflective mirrors 97a and 97b so as to enter the chamber 92 again via the window 96. Thereafter, the amplified laser beam L1 may be emitted from the chamber 92 via the window 93.

A part of the laser beam L1 that has passed through the amplification region within the chamber 92 twice in the manner described above may be outputted via the output coupler 91. The remaining laser beam L1, which has been reflected by the output coupler 91, may travel on the optical path formed by the output coupler 91 and the highly reflective mirrors 91a, 91b, 97a and 97b so as to be amplified again.

### 9. Spectrum Detecting Unit

The spectrum detecting unit 63 shown in FIG. 1 will be described with reference to the drawings.

### 9.1 Monitor Etalon Spectroscope

At first, the spectrum detecting unit 63 using a monitor etalon is described in detail referring to the drawings. FIG. 23 schematically illustrates a general configuration of the spectrum detecting unit 63. As shown in FIG. 23, the spectrum detecting unit 63 may include a diffusing plate 701, a monitor etalon 702, a focusing lens 703, and an image sensor 705 (or a photodiode array).

A laser beam L1 having passed through the attenuation unit 62 may be incident on the diffusing plate 701 first. The diffusing plate 701 may scatter the incident laser beam L1. The scattered beam of light may enter the monitor etalon 702. The monitor etalon 702 may be an air gap etalon in which two mirrors are bonded sandwiching a spacer therebetween to face each other at a predetermined interval; each mirror is made of a substrate which transmits the laser beam L1 and whose surface is coated with a partial reflection film. Of the scattered beam of light having entered the monitor etalon 702, the monitor etalon 702 may transmit the scattered beam of light having a predetermined wavelength. The transmitted beam of light may enter the focusing lens 703. The image sensor 705 may be disposed at a focal plane of the focusing lens 703. The transmitted beam of light focused by the focusing lens 703 can generate an interference fringe on the image sensor 705. The image sensor 705 may detect the generated interference fringe. The second power of the radius of the interference fringe can be proportional to the wavelength of the laser beam L1. Therefore, an entire spectrum of the laser beam L1 can be detected from the detected interference fringe. From the detected spectrum, each spectral bandwidth, peak intensity and wavelength may be obtained with an information processing apparatus (not shown) or calculated by the controller 10.

Dousers 704 may be provided between the focusing lens 703 and the image sensor 705. This makes it possible to reduce stray light within the detected beam of light and in turn obtain an interference fringe with high precision.

### 9.2 Grating Spectroscope

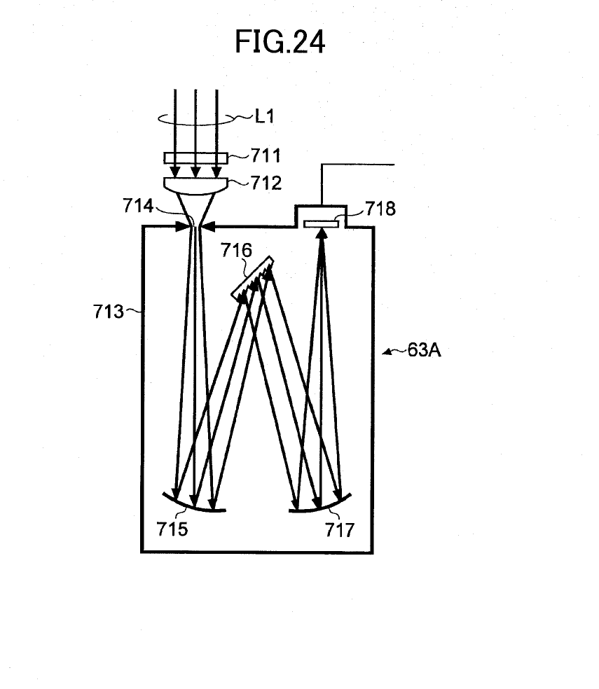

Next, a spectrum detecting unit 63A using a grating spectroscope is described in detail with reference to the drawings. FIG. 24 schematically illustrates a general configuration of the spectrum detecting unit 63A. As shown in FIG. 24, the spectrum detecting unit 63A may include a diffusing plate 711, a focusing lens 712, and a spectroscope 713. The spectroscope 713 may include concave mirrors 715 and 717, a grating 716, and an image sensor (line sensor) 718.

A laser beam L1 that has passed through the attenuation unit 62 may be incident on the diffusing plate 711 first. The diffusing plate 711 may scatter the incident laser beam L1. The scattered beam of light may enter the focusing lens 712. An incidence slit 714 of the spectroscope 713 may be disposed in the vicinity of a focal plane of the focusing lens 712. The incidence slit 714 may be positioned slightly ahead of the focal plane of the focusing lens 712 toward the upstream side. The scattered beam of light focused by the focusing lens 712 may be incident on the concave mirror 715 through the incidence slit 714. The concave mirror 715 may convert part of the incident scattered beam of light to a collimated beam of light and reflect this collimated beam of light.

The reflected beam of light may be incident on the grating 716. The grating 716 may diffract the incident collimated beam of light. Part of the diffracted beam of light may be incident on the concave mirror 717. The concave mirror 717 may focus the incident diffracted beam of light so as to reflect it. The image sensor 718 may be disposed at a focal plane of the concave mirror 717. In this case, the reflected beam of light focused by the concave mirror 717 can form an image on the image sensor 718. The image sensor 718 may detect the distribution of light intensity at the position of the formed image. The position of the formed image can be proportional to the wavelength of the corresponding laser beam L1. This makes it possible to detect an entire spectrum of the laser beam L1 from the detected position of the formed image. From the detected spectrum, each spectral bandwidth, peak intensity, and wavelength may be obtained with an information processing apparatus (not shown) or calculated by the controller 10.

The aforementioned descriptions are intended to be taken only as examples, and are not to be seen as limiting in any way. Accordingly, it will be clear to those skilled in the art that variations on the embodiments of the present disclosure can be made without departing from the scope and spirit of the appended claims.

The terms used in this specification and the appended claims should be construed as non-limiting. For example, the terms “comprise” and “include” should be construed as “include but not be limited to”. The term “have” should be construed as “have but not be limited to”. An indefinite article “a/an” used in this specification and the appended claims should be construed as “at least one” or “one or more”.

The terms used in the present specification and in the entirety of the scope of the appended claims are to be interpreted as not being limiting. For example, wording such as “includes” or “is included” should be interpreted as not being limited to the item that is described as being included. Furthermore, “has” should be interpreted as not being limited to the item that is described as being had. Furthermore, the indefinite article “a” or “an” as used in the present specification and the scope of the appended claims should be interpreted as meaning “at least one” or “one or more.”

What is claimed is:

1. A laser apparatus comprising:
a laser oscillator capable of tuning a spectral bandwidth of a laser beam to be outputted therefrom;
a spectrum detecting unit that detects a spectrum of the laser beam outputted from the laser oscillator; and
an attenuation unit capable of regulating light intensity of the laser beam that enters the spectrum detecting unit.

2. The laser apparatus according to claim 1,
wherein the attenuation unit includes:
a variable attenuator whose transmittance varies depending on an incident position of the laser beam; and
a movement mechanism that moves the variable attenuator so that the incident position of the laser beam is changed.

3. The laser apparatus according to claim 2,
wherein the variable attenuator is formed in a rotary disk shape, and
the movement mechanism rotates the variable attenuator so as to change the incident position of the laser beam.

4. The laser apparatus according to claim 2,
wherein the variable attenuator is formed in a flat plate shape, and
the movement mechanism slides the variable attenuator so as to change the incident position of the laser beam.

5. The laser apparatus according to claim 1,
wherein the attenuation unit includes:
a substrate in which a dielectric multilayer film whose transmittance varies in accordance with an incident angle thereto is formed; and
a rotation mechanism that changes the incident angle of the laser beam to the substrate.

6. The laser apparatus according to claim 1,
wherein the attenuation unit includes:
a first substrate in which a dielectric multilayer film whose transmittance varies in accordance with an incident angle thereto is formed;
a first rotation mechanism that changes the incident angle of the laser beam to the first substrate;
a second substrate in which a dielectric multilayer film whose transmittance varies in accordance with an incident angle thereto is formed; and
a second rotation mechanism that changes the incident angle of the laser beam, which has passed through the first substrate, to the second substrate in the opposite direction to the direction in the first rotation mechanism.

7. The laser apparatus according to claim 1, further comprising:
a controller that tunes an attenuation rate of the attenuation unit so that peak intensity of the laser beam that enters the spectrum detecting unit falls in a predetermined dynamic range.

8. The laser apparatus according to claim 7,
wherein the controller tunes the attenuation rate of the attenuation unit based on the spectrum detected by the spectrum detecting unit.

9. The laser apparatus according to claim 8, further comprising:
an energy detector that detects pulse energy of the laser beam outputted from the laser oscillator,
wherein the controller tunes the attenuation rate of the attenuation unit based on the pulse energy detected by the energy detector.

10. The laser apparatus according to claim 7,
wherein the aforementioned laser oscillator includes:
an optical resonator that is configured including an output coupling mirror and a grating;
a magnification adjusting unit capable of adjusting a beam diameter of the laser beam travelling in the optical resonator; and
a wave-front tuning unit capable of tuning a wave-front of the laser beam travelling in the optical resonator, and
wherein the controller tunes at least one of the magnification adjusting unit and the wave-front tuning unit based on the spectrum detected by the spectrum detecting unit.

11. The laser apparatus according to claim 7,
wherein the controller inputs a target spectral bandwidth from exterior and tunes the aforementioned attenuation unit in accordance with the target spectral bandwidth.

12. The laser apparatus according to claim 1,
wherein the spectrum detecting unit is a spectroscope including an etalon.

13. The laser apparatus according to claim 1,
wherein the spectrum detecting unit is a spectroscope including a grating.

14. The laser apparatus according to claim 1, further comprising:
an amplifying apparatus that amplifies the laser beam outputted from the aforementioned laser oscillator; and
a beam splitter that splits the laser beam amplified by the amplifying apparatus,
wherein the attenuation unit and the spectrum detecting unit are disposed on an optical path of the laser beam split by the beam splitter.
